(19) United States
(12) Patent Application Publication
(10) Pub. No.: US 2008/0083155 A1
(43) Pub. Date: Apr. 10, 2008

(54) Hide-able square snare

(76) Inventor: Carl Russel Waybright, Buckhannon, WV (US)

Correspondence Address: Carl Waybright, Rt. 1 Box 300B, Buckhannon, WV, 26201, US

(21) Appl. No.: 11/545,850

(22) Filed: Oct. 10, 2006

(51) Int. Cl. A01M 23/34

(52) U.S. Cl. 43/87; 43/85

(57) ABSTRACT

This invention relates to a structure of a snare that is designed to reduce animal awareness of the presence of the snare. The structure of the snare includes: 40″ of 3/32″ steel cable which is crimped three times in 8″ increments from one end, two ⅛″ steel nuts that are crimped onto one end of the cable opposite the crimped end, a 1¼″ round cut piece of ⅕″ thick steel that has holes drilled on opposite sides and is shaped to a 90 degree angle from the middle which slides on the cable, 8″ of small gauge steel wire that is looped and affixed to the end of the cable with the two steel nuts, a small aluminum swagger that is crimped on the end of the 3/32″ steel cable opposite the two nuts and a ⅛″ steel washer that slides on the cable prior to the swagger being attached.

### SUMMARY DESCRIPTION

The “Hide-able Square Snare” consists of a thin steel braided cable that connects back to itself at one end of the cable. The connection is achieved through crimping of the steel cable at 90 degree angles so as to form a square. The other end of the cable has a swivel that allows the snare to be affixed to a solid object for the purpose of trapping small to medium animals. The snare is set suspended above the ground near an animal burrow, or trail. When the animal passes part of its body through the snare, the snare tightens, holding the animal indefinitely.

While snare traps do exist, they achieve the snare design by way of a circular or loop connection. This connection is much more difficult to conceal from the view of animals that must pass through the snare in order to be effectively captured. As well, this steel cable loop is less familiar to the animals, which often encounter square fence wire, allowing a square snare to be less alarming. The “Hide-able Square Snare” is the first to utilize a design that allows the loop of a snare to effectively close around an animal while initially being set in a square position.

This square snare can be concealed behind square steel fencing, or easily hidden behind trees or branches along a path, as pictured in the “drawings”. The original loop design snare is less effective, as it is often visible to the animal, which can avoid passing through.

### Specification

### Required Tools for Manufacture

### Large Table Mounted Vice

### Steel Anvil

### Regular Claw Hammer

### Pliers

### Power Drill

⅛″ Drill Bit
3/16″ Drill Bit

### Required Materials for Manufacture

### 40 Inches of 3/32″ Steel Braided Cable

2—⅛″ Steel Nuts

### 1 Small Aluminum Swagger

1—⅛″ Steel Washer

### 8 Inches of Small Gauge Steel Wire

1—1¼″ Round Cut ⅕″ Thick Steel Piece

### Steps to Create

### Creating the Catch Opening

Take the steel cable and measure up 8″ from the end. Fold the cable at that 8″ mark.
Using the pliers, at the crux of the cable, apply sufficient pressure as to change the loop-like shape of the fold into a crimped piece of steel cable that makes a 90 degree angle.
At the point of the newly created crimp, measure back an additional 8″ and repeat the crimping process.
Repeat the above step again.

### Creating the Tray Slide

Take the 1¼″ Round Cut ⅕″ Thick Steel Piece and close it in the Large Table Top Vice with Just over 50% of the piece visible.
Using the claw hammer, pound the piece of steel at an angle, until it is bent at a perfect 90 degree angle.
Using the Power Drill with the ⅛″ bit, near the outer edge of the apex of the visible side of the steel piece, drill a hole completely through.
Release the piece from the vice, place the piece back in with the opposite side visible and re-close.
Using the Power Drill with the 3/16″ bit, near the outer edge of the apex of the visible side of the steel piece, drill a hole completely through.

### Affixing the Trap Slide

Place the trap slide on the cable by passing the steel cable through one of the two holes drilled in the slide.
Place the end of the steel cable on top of the anvil. At nearly the very end of the cable, slide on one of the steel nuts.
Pound it with the claw hammer until it clasps tightly around the cable.
Repeat the step above with the second nut.
Pass the other end of the cable through the other hole in the trap slide.

### Affixing the Swagger

Place the end of the steel braided cable that does not have a nut attached on the anvil. Slide the ⅛″ steel washer on the end of the cable.
Then slide the swagger on after the washer.
Place the swagger on the anvil with the cable barely protruding though it.
Using the claw hammer, pound the swagger until it closes tightly on the cable.

### Creating the Swivel

Place a small part of the end of the small gauge steel wire in the vice.
Using the pliers, create a 1 to 1½″ loop near the middle of the wire.
Holding one piece of the wire in the vice and one piece of the wire in the pliers, place the end of the cable with the swagger attached in between the two pieces of the loop.
Tightly wrap the two ends of wire around the cable, keeping the loop intact.
Ensure that the wrap is tight enough to prevent the wire from sliding over the swagger.

### Steps to Use

Locate an animal burrow or game trail in the wilderness.
Find a place near the burrow or trail where there is a square or partially square obstruction that can conceal the trap.
Affix the swivel to a nearby tree or solidly affixed penetrable anchor by using a claw hammer and nail to attach it.
Gently hang the snare on a convenient protrusion or irregularity of the material, positioning it so as to conceal its existence.
When an animal passes its head through the snare it will gently tighten, securing the animal so as to prevent it from moving away. As the animal pulls, it will tighten more secure. When the animal relaxes, the snare will as well.
Return to check the snare daily to verify if an animal is present.
When an animal is present, subdue the animal and re-set the snare.

### BACKGROUND OF INVENTION

### Field of Endeavor

### Hunting and Trapping, Small to Medium Game

### US patent Classification #

### Class 43, Fishing, Trapping and Vermin Destroying

### BRIEF DESCRIPTION OF THE DRAWINGS/PICTURES

FIG. 1—Drawing of Assembled “Hide-able Square Snare” Open In this drawing you can see the basic configuration of the parts that are detailed in the earlier sections of this document. The snare is in the open position, meaning that the 3/32″ steel cable (3) is pulled through the trap slide until the clasped steel nuts (1) are almost pulled against the steel trap slide (2).

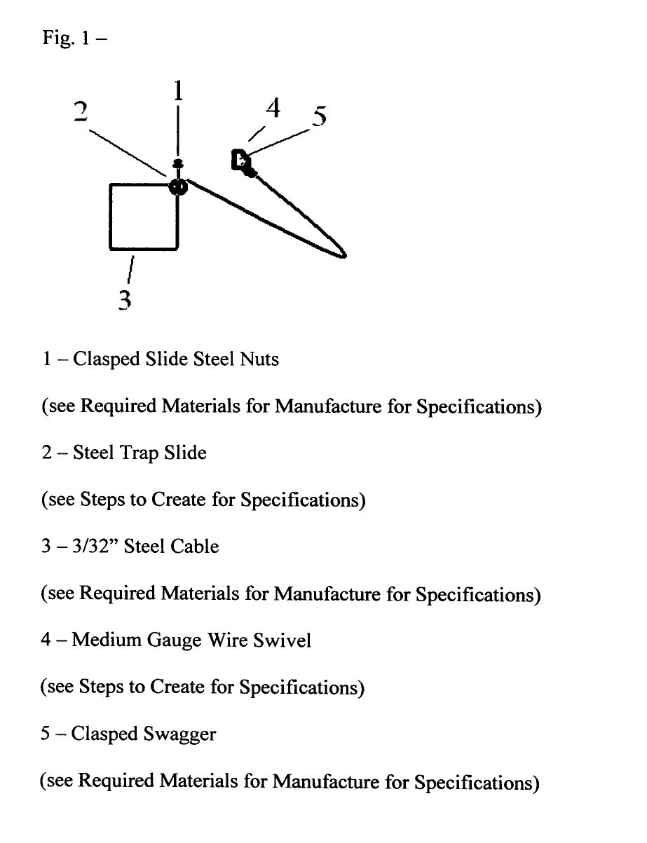

FIG. 2—Drawing of “Hide-able Square Snare” Closed In this drawing, the loop has been closed. This occurs when an animal attempts to pass through the snare, causing sufficient pressure that the trap slide (2) moves toward the animal as the 3/32″ steel cable (3) passes through it in such a way that the cable end with clasped steel nuts (1) is moving away from the trap slide (2).

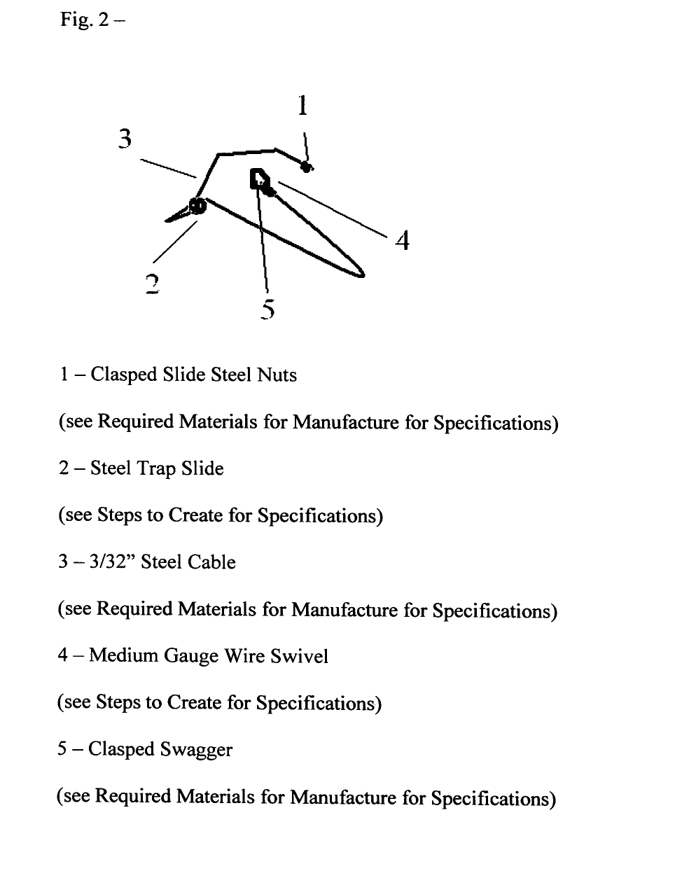

FIG. 3—Drawing of Current Loop Snare Design Open In this drawing, the existing marketed snare trap is shown. It varies from the new design in that it is not constructed to have or allow a square snare end.

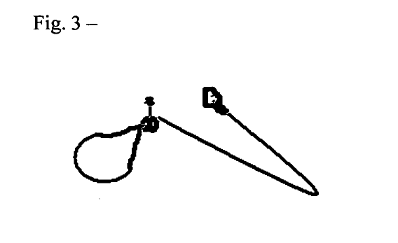

FIG. 4—Drawing of Current Loop Snare Design Closed In this drawing, we see the existing snare in its closed position. This means that pressure has been applied to the loop causing it to tighten.

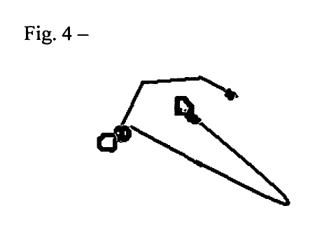

FIG. 5—Picture of Complete “Hide-able Square Snare” Open This picture is of a “Hide-able Square Snare” that I fabricated using the above process. It is in the open position, where the loop is open and the clasped steel nuts are resting on the trap slide.

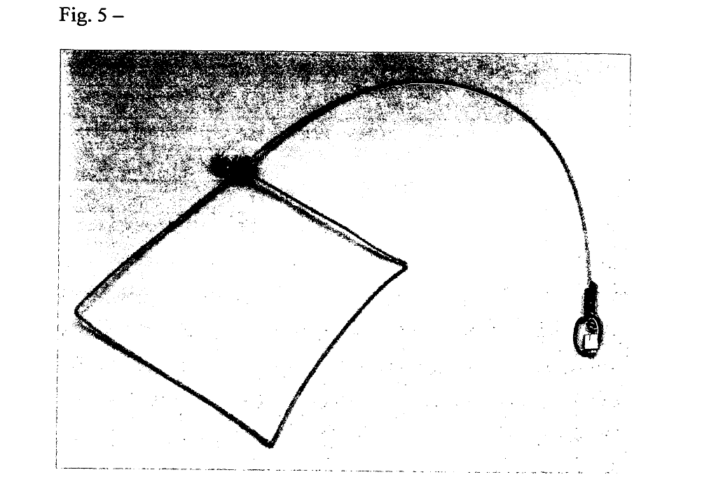

FIG. 6—Picture of Complete “Hide-able Square Snare” Closed This picture is of a “Hide-able Square Snare” that I fabricated using the above process. It is in the closed position, where the loop is closed and the clasped steel nuts are far from the trap slide due to the steel cable passing through.

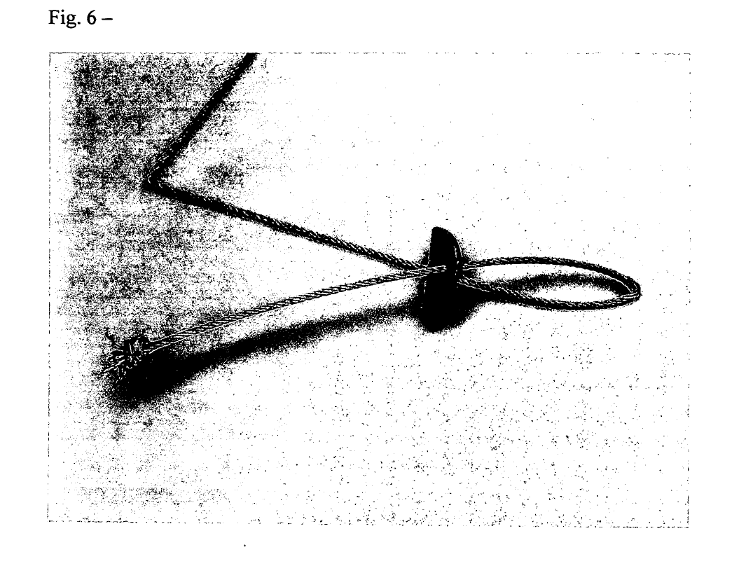

FIG. 7—Picture of “Hide-able Square Snare” in Use This picture shows a “Hide-able Square Snare” in position for use. It has been concealed, as is the purpose of its design, by resting it between limbs off of a tree and near a wire fence. You can identify the trap slide (1) and the steel cable (2).

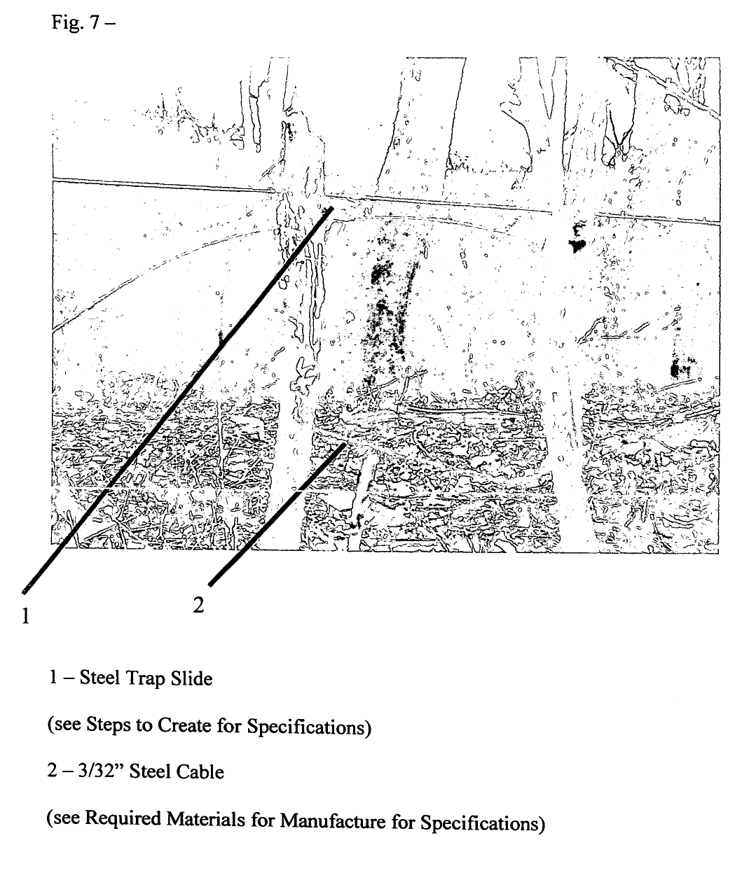

FIG. 8—Picture of “Hide-able Square Snare” in Use This picture is of the exact same positioning as FIG. 7, with the exception that it was taken from a distance of a few feet, as opposed to immediately in front of the snare. You can identify the trap slide (1) and the steel cable (2), though faintly in this picture.

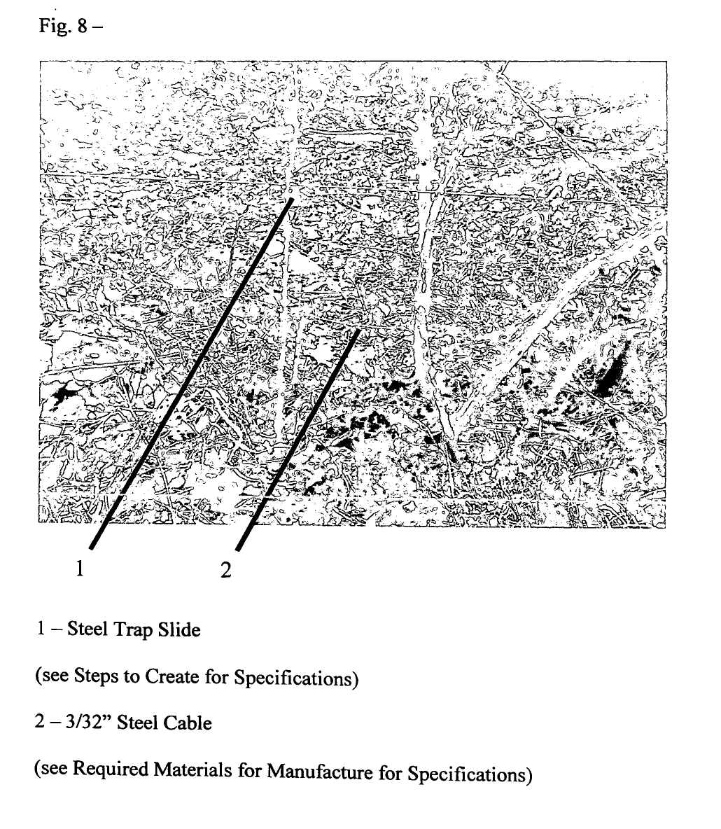

FIG. 9—Picture of Original Loop Snare in Use This picture shows the typical positioning of the existing loop snare design, as it would be implemented. It is suspended from a wire fence. It would be much more difficult to conceal due to its variation in loop width, height and oblong shape.

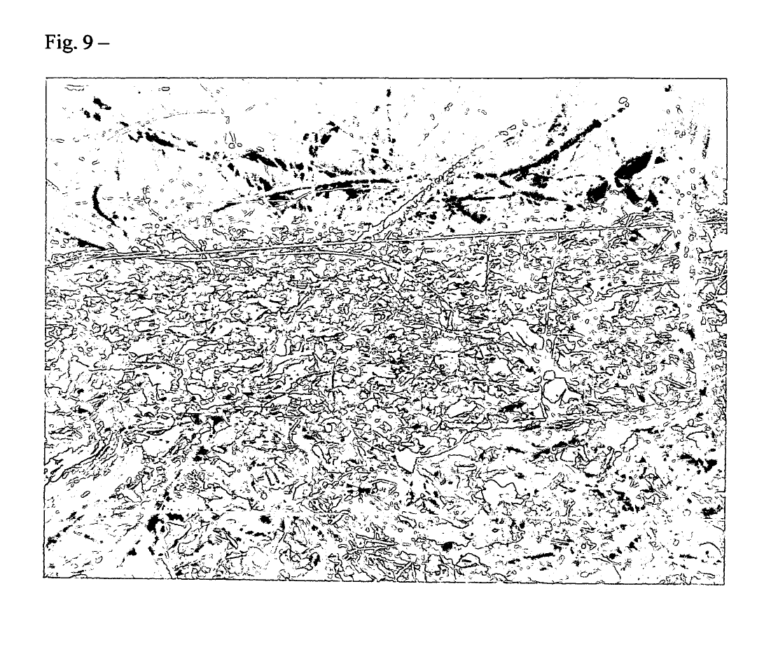

1. The invention that is being claimed in this patent application for the “Hide-able Square Snare” is the square design of the snare opening in which the animal is trapped.
Currently, a square snare is neither marketed nor obtainable from any firm I have been able to identify as an avid hunter and trapper.
When used properly in conjunction with concealment, the square snare end is much more effective than the loop, as the square end is a less alarming shape. Animals frequently encounter square wire fences, which do not trap them. This helps ease any potential concern the animal may have over the existence of the trap. The shape is common in their world.
As well, the square end is much easier to conceal, as a square fence or two adjacently growing tree trunks frequently occur in the animals' habitat. An existing loop shape to conceal a loop snare is a much less common occurrence.
My intention in filing this application is to obtain exclusive rights to a snare trap which has a square snare end.
